(19) United States
(12) Patent Application Publication
(10) Pub. No.: US 2017/0237691 A1
(43) Pub. Date: Aug. 17, 2017

(54) APPARATUS AND METHOD FOR SUPPORTING MULTIPLE VIRTUAL SWITCH INSTANCES ON A NETWORK SWITCH

(71) Applicant: CAVIUM, INC., San Jose, CA (US)

(72) Inventor: Ravindran Suresh, San Jose, CA (US)

(21) Appl. No.: 15/042,526

(22) Filed: Feb. 12, 2016

(51) Int. Cl. H04L 12/931; H04L 12/935; H04L 12/741

(52) U.S. Cl. CPC H04L 49/70; H04L 45/745; H04L 49/3063

(57) ABSTRACT

A network switch to support multiple virtual switch instances comprises a control CPU configured to run a plurality of network switch control stacks, wherein each of the network switch control stacks is configured to manage and control operations of one or more virtual switch instances of a switching logic circuitry of the network switch. The network switch further includes said switching logic circuitry partitioned into a plurality of said virtual switch instances, wherein each of the virtual switch instances is provisioned and controlled by one of the network switch control stacks and is dedicated to serve and route data packets for a specific client of the network switch.

### TECHNICAL FIELD

The present application relates to communications in network environments. More particularly, the present invention relates to virtualization of a high speed network processing unit.

### BACKGROUND

Network switches/switching units are at the core of any communication network. A network switch typically has one or more input ports and one or more output ports, wherein data/communication packets are received at the input ports, processed by the network switch through multiple packet processing stages, and routed by the network switch to other network devices from the output ports according to control logic of the network switch.

Web service providers/clients have been increasingly hosting their web services (e.g., web sites) on hosts/servers at the data centers in public or private clouds, where high-speed, high throughout network switches are widely used to route data communications between the clients and the web services hosted by the servers in the data centers. Here, the network switches can be organized in a multi-tier topology as top of the rack (TOR) leaf switches or spine switches, wherein each spine switch connects to and aggregates data traffic from a plurality of TOR switches. Each of the TOR switches may support multiple servers each hosting different web services for different clients. Currently, each network switch is entirely controlled by a single set of software instructions irrespective of the number of clients it supports. Since different clients may have different requirements or service level agreements (SLAs) for network data security, privacy, data sharing, and data packet processing, it would be desirable for each of the clients to have its own dedicated virtual network switch instance on a single physical network switch.

The foregoing examples of the related art and limitations related therewith are intended to be illustrative and not exclusive. Other limitations of the related art will become apparent upon a reading of the specification and a study of the drawings.

### SUMMARY

A network switch to support multiple virtual switch instances comprises a control CPU configured to run a plurality of network switch control stacks, wherein each of the network switch control stacks is configured to manage and control operations of one or more virtual switch instances of a switching logic circuitry of the network switch. The network switch further includes said switching logic circuitry partitioned into a plurality of said virtual switch instances, wherein each of the virtual switch instances is provisioned and controlled by one of the network switch control stacks and is dedicated to serve and route data packets for a specific client of the network switch.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views.

FIG. 1 illustrates an example of a diagram of a network switch configured to support multiple virtual switch instances in accordance with some embodiments.

FIG. 2 illustrates an example of an architectural diagram of the switching logic depicted in the example of FIG. 1 in accordance with some embodiments.

FIG. 3 illustrates examples of formats used for communications between a requesting data processing pipeline and its corresponding search logic unit in accordance with some embodiments.

FIG. 4 depicts an example of a search profile maintained and used by the search logic unit in accordance with some embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

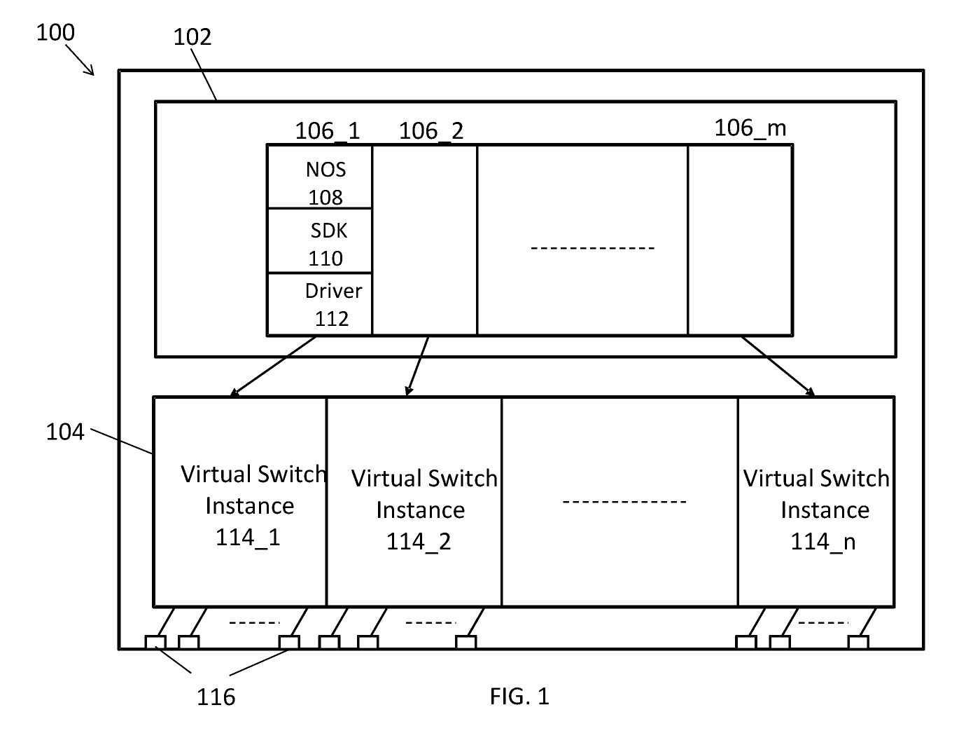

FIG. 1 illustrates an example of a diagram of a network switch/router 100 configured to support multiple virtual switch instances. Although the diagrams depict components as functionally separate, such depiction is merely for illustrative purposes. It will be apparent that the components portrayed in this figure can be arbitrarily combined or divided into separate software, firmware and/or hardware components.

In the example of FIG. 1, the network switch 100 includes a control CPU or microprocessor 102 and a switching logic circuitry 104. Here, the control CPU 102 is configured to execute one or more set of software instructions for practicing one or more processes. Specifically, the control CPU is configured to run a plurality of network switch control stacks 106_1, . . . , 106_m, which are software components. When the network switch 100 is first powered up, the network switch control stacks 106 are loaded from a storage unit (not shown) of the network switch 100 and executed/launched on the control CPU 102, wherein each of the network switch control stacks 106 is configured to manage and control operations of one or more virtual switch instances 114 of the switching logic circuitry 104 of the network switch 100 as discussed in details below.

In some embodiments, each of the network switch control stacks 106 includes a network operating system (NOS) 108, a switch software deployment kit (SDK) 110, and a switch configuration interface driver 112 for one or more virtual switch instances 114. Here, the NOS 108 is a comprehensive software configured to implement a network communication protocol for data communication with one of the clients of the network switch 100 via one or more of the virtual switch instances 114. In addition to other software modules required to manage the network switch 100, the NOS 108 may further include one or more of protocol stacks, including not limited to one of, Open Shortest Path First (OSPF) protocol, which is a routing protocol for Internet Protocol (IP) networks, Border Gateway Protocol (BGP), which is a standardized exterior gateway protocol designed to exchange routing and reachability information among autonomous systems (AS) on the Internet, and Virtual Extensible LAN (Vxlan) Protocol, which is a network virtualization technology that attempts to improve the scalability problems associated with large cloud computing deployments

The switch SDK 110 is configured to control routing configurations of the virtual switch instances 114 and the switch configuration interface driver 112 is configured to control and configure a configurable communication bus (e.g., PCIe/I²C/MDIO, etc.) between the network switch control stack 106 and the virtual switch instances 114. In some embodiments, setting and configurations of the switch SDK 110 of the network switch control stack 106 are adjustable by a user (e.g., network system administrator) via a user interface (not shown) provided by the network switch 100. In some embodiments, different network switch control stacks 106 running on the same control CPU 102 of the network switch 100 may have different types of NOS 108s that are completely unrelated to each other.

In the example of FIG. 1, the switching logic circuitry 104 is an application specific integrated circuit (ASIC), which is partitioned into a plurality of virtual switch instances 114_1, . . . , 114_n, wherein each of the virtual switch instances is provisioned and controlled by one of the network switch control stacks 106 and is dedicated to serve and route data packets for a specific client/web service host. In some embodiments, a network switch control stack 106 is configured to control only one virtual switch instance 114 and different virtual switch instances 114 are controlled by different network switch control stacks 106. In some alternative embodiments, a network switch control stack 106 is configured to control multiple virtual switch instances 114. As such, in some embodiments, part of the switching logic circuitry 104 is controlled by one network switch control stack 106 while another part of the switching logic circuitry 104 is controlled by another network switch control stack 106.

In the example of FIG. 1, the network switch 100 further includes a plurality of I/O ports 116, partitioned among the plurality of virtual switch instances 114 and controlled by the network switch control stacks 106. Here, each I/O port 116 supports data transmission at various speeds, e.g., 1/10/25/100 Gbps. In some embodiments, each I/O port 116 is configured to transmit data packets between a client and its corresponding virtual switch instance 114 independent and separate from the data traffic between other clients and their virtual switch instances 114. For a non-limiting example, when the network switch 100 has 128 I/O ports 116 and four virtual switch instances 114, each virtual switch instance 114 may be allocated 32 I/O ports, wherein the corresponding network switch control stack 106 of the virtual switch instance 114 can only access and control these 32 I/O ports.

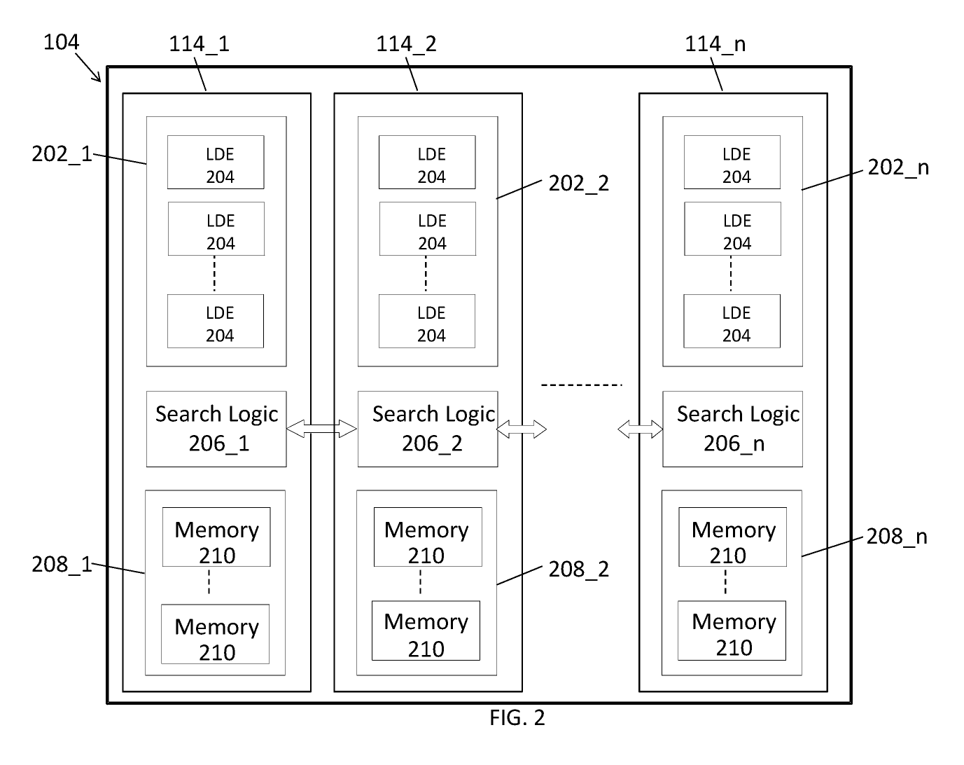

FIG. 2 illustrates an example of an architectural diagram of the switching logic circuitry 104 depicted in the example of FIG. 1. As shown in the example of FIG. 2, each of the virtual switch instances 114 further includes a data processing pipeline 202, a search logic unit 206 associated with the corresponding data processing pipeline 202, and a local memory cluster 208, all identified by the same virtual switch ID of the virtual switch instance 114. Here, each data processing pipeline 202 is configured to process/route a received data packet through multiple processing/routing stages based on table search results. In some embodiments, the packet processed by the data processing pipeline 202 can also be modified and rewritten (e.g., with the header of the packet stripped) to comply with protocols for transmission over a network. Each of the data processing pipeline 202 interacts with its corresponding search logic unit 206, which serves as an interface between the data processing pipeline 202 and the memory cluster 208 configured to maintain routing/forwarding tables to be searched by the search logic unit 206.

Table search has been widely adopted for the control logic of the network switch 100, wherein the network switch 100 performs search/lookup operations on the tables stored in the memory of the network switch for each incoming packet and takes actions as instructed by the table search results or takes a default action in case of a table search miss. Examples of the table search performed in the network switch 100 include but are not limited to: hashing for a Media Access Control (MAC) address look up, Longest-Prefix Matching (LPM) for Internet Protocol (IP) routing, wild card matching (WCM) for an Access Control List (ACL) and direct memory access for control data. The table search in the network switch allows management of network services by decoupling decisions about where traffic/packets are sent (i.e., the control plane of the switch) from the underlying systems that forwards the packets to the selected destination (i.e., the data plane of the switch), which is especially important for Software Defined Networks (SDN).

In the example of FIG. 2, each data processing pipeline 202 further comprises a plurality of lookup and decision engines (LDEs) 204 connected in a chain, wherein, as one of the processing stages in the data processing pipeline 202, each LDE 204 is configured to generate a master table lookup key for a packet received and to process/modify the packet received based on search results of the tables by the search logic unit 206 using the master table lookup key. Specifically, each LDE 204 examines specific fields and/or bits in the packet received to determine conditions and/or rules of configured protocols and generates the master lookup key accordingly based on the examination outcomes. The LDE 204 also checks the table search results of the master lookup key to determine processing conditions and/or rules and to process the packet based on the conditions and/or rules determined. Here, the conditions and/or rules for key generation and packet processing are fully programmable by software and are based on network features and protocols configured for the processing stage of the LDE 204.

In the example of FIG. 2, each data processing pipeline 202 has its own corresponding local memory cluster 208, which the data processing pipeline 202 interacts with for search of the tables stored there through its corresponding search logic unit 206 as discussed below. In some embodiments, each data processing pipeline 202 is allowed to access its own local memory cluster 208 only. In some alternative embodiments, each data processing pipeline 202 is further configured to access other (e.g., neighboring) memory clusters 208s in addition to or instead of its own local memory cluster 208 through its corresponding search logic unit 206, if the tables to be searched are stored across multiple memory clusters 208s.

In some embodiments, each memory cluster 208 includes a variety of memory tiles 210 that can be but are not limited to a plurality of static random-access memory (SRAM) pools and/or ternary content-addressable memory (TCAM) pools. Here, the SRAM pools support direct memory access and each TCAM pool encodes three possible states instead of two with a “Don't Care” or “X” state for one or more bits in a stored data word for additional flexibility. In some embodiments, the memory tiles 210 can be flexibly configured to accommodate and store different table types as well as entry widths. Since certain memory operations such as of hash table and LPM table lookup may require access to multiple memory pools for best memory efficiency, the division of each memory cluster 108 into multiple separate pools allows for parallel memory accesses.

In the example of FIG. 2, the search logic unit 206 is configured to accept and process a unified table request from its corresponding data processing pipeline 202, wherein the unified table request includes the master table lookup key. The search logic unit 206 identifies the memory cluster 208 that maintain the tables to be searched, constructs a plurality of search keys specific to the memory cluster 208 based on the master lookup key and transmit a plurality of table search requests/commands to the memory clusters 208, wherein the search request/command to the memory cluster 208 includes identification/type of the tables to be searched and the search key specific to the memory cluster 208. In some embodiments, the search logic unit 106 is configured to generate the search keys having different sizes to perform different types of table searches/lookups specific to the memory cluster 208. In some embodiments, the sizes of the search keys specific to the memory clusters 108 are much shorter than the master lookup key to save bandwidth consumed between the search logic unit 206 and the memory cluster 208. Once the table search across the memory cluster 208 is done, the search logic unit 206 is configured to collect the search results from the memory cluster 208 and provide the search results to its corresponding data processing pipeline 202 in a unified response format.

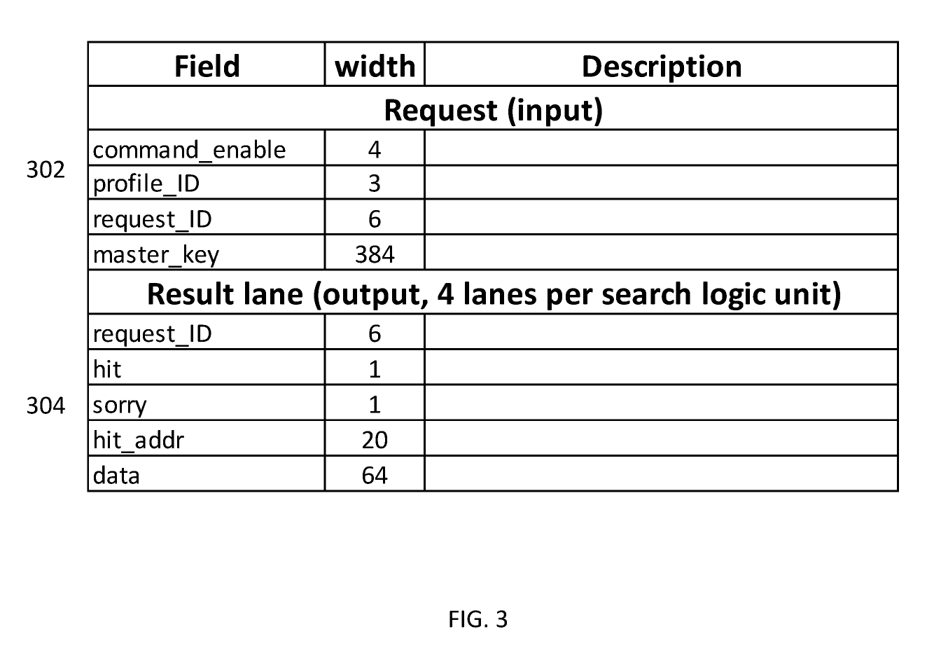

FIG. 3 illustrates examples of formats used for communications between the requesting data processing pipeline 202 and its corresponding search logic unit 206. As depicted by the example in FIG. 3, the unified table request 302 sent by the data processing pipeline 202 to the search logic unit 206 includes the master lookup key, which can be but is not limited to 384 bits in width. The unified table request 302 further includes a search profile ID, which identifies a search profile describing how the table search/lookup should be done as discussed in details below. Based on the search profile, the search logic unit 206 can then determine the type of table searched/lookup, the memory clusters 208s to be searched, and how the search keys specific to the memory clusters 208s should be formed. Since there are three bits for the profile ID in this example, there can be up to eight different search profiles. The unified table request 302 further includes a request_ID and a command_ID, representing the type of the request and the search command to be used, respectively.

In some embodiments, the search logic unit 206 is configured to transmit the lookup result back to the requesting data processing pipeline 202 in the unified response format as a plurality of (e.g., four) result lanes as depicted in the example of FIG. 3, wherein each result lane represents a portion of the search results. As depicted in FIG. 3, each result lane 504 has a data section representing a portion of the search result (e.g., 64 bits wide), the same request_ID as in unified table request 302, a hit indicator and a hit address where a matching table entry is found. As such, the search logic unit 206 may take multiple cycles to return the complete search results to the requesting data processing pipeline 202.

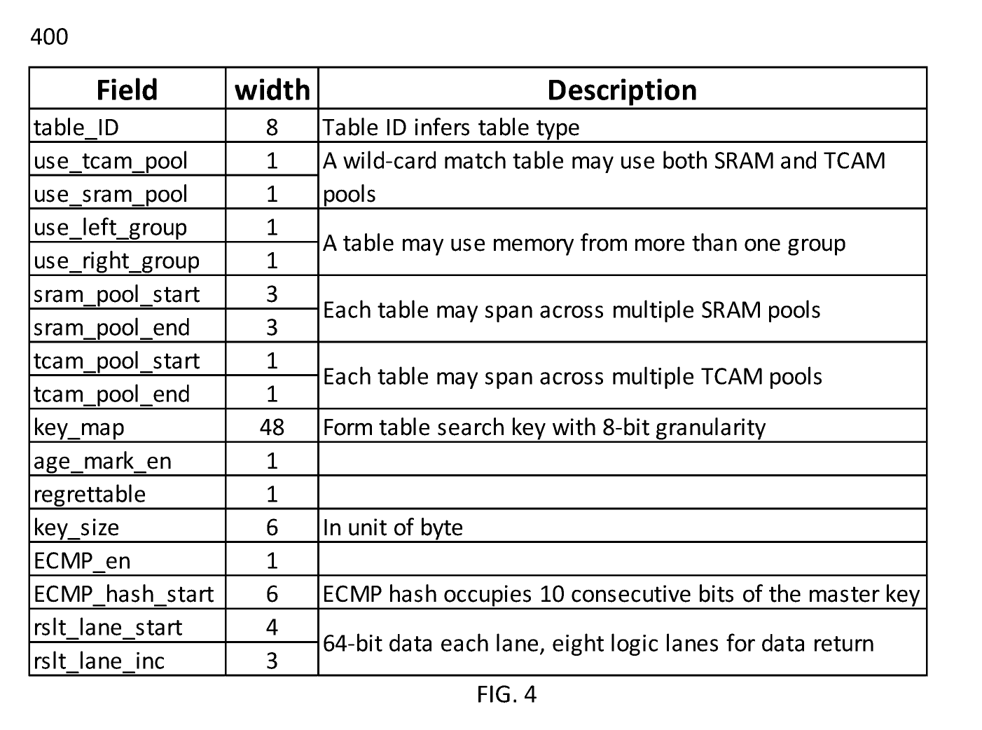

FIG. 4 depicts an example of a search profile 400 maintained and used by the search logic unit 206, which uses the search profile 400 identified in the unified table request 302 in FIG. 3 to generate the plurality of table search requests in parallel to the memory clusters 208s. As shown in the example in FIG. 4, the search profile 400 include information on the types of memory clusters/pools to be searched, the identification of the memory clusters/pools to be searched, the types of table search/lookup to be performed, how the search keys should be generated from the master lookup key that are specific to the memory pools, and how the search results should be provided back to the requesting data processing pipeline 202. Here, the search profile 400 indicates whether the search will be performed to the memory cluster 208 local to the requesting data processing pipeline 202 and the search logic unit 206 and/or to one or more neighboring memory clusters 208s in parallel as well. The search range within each of the memory clusters 208s is also included in the search profile 400.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

What is claimed is:

1. A network switch to support multiple virtual switch instances, comprising:
a control CPU configured to run a plurality of network switch control stacks, wherein each of the network switch control stacks is configured to manage and control operations of one or more virtual switch instances of a switching logic circuitry of the network switch;
said switching logic circuitry partitioned into a plurality of said virtual switch instances, wherein each of the virtual switch instances is provisioned and controlled by one of the network switch control stacks and is dedicated to serve and route data packets for a specific client of the network switch.

2. The network switch of claim 1, wherein:
each of the network switch control stacks includes
a network operating system (NOS) configured to implement a network communication protocol for data communication with the client via the one or more virtual switch instances;
a switch software deployment kit (SDK) configured to control routing configuration of the virtual switch instances; and
a switch configuration interface driver configured to control and configure a configurable communication bus between the network switch control stack and the virtual switch instances.

3. The network switch of claim 2 wherein:
the NOS includes one or more of Open Shortest Path First (OSPF) protocol, Border Gateway Protocol (BGP), and Virtual Extensible LAN (Vxlan) Protocol.

4. The network switch of claim 2 wherein:
different network switch control stacks running on the control of the network switch have different types of the NOS that are completely unrelated to each other.

5. The network switch of claim 1 wherein:
the switching logic circuitry is an application specific integrated circuit (ASIC).

6. The network switch of claim 1 wherein:
one of the network switch control stacks is configured to control only one virtual switch instance and different virtual switch instances are controlled by different network switch control stacks.

7. The network switch of claim 1 wherein:
one of the network switch control stacks is configured to control multiple of the virtual switch instances.

8. The network switch of claim 1 further comprising:
a plurality of I/O ports partitioned among the plurality of virtual switch instances and controlled by the network switch control stacks, wherein each of the I/O ports is configured to transmit the data packets between the client and its corresponding virtual switch instance independent and separate from the data traffic between other clients and their virtual switch instances.

9. The network switch of claim 1 wherein:
each of the virtual switch instances further includes
a data processing pipeline configured to process and route the data packets through multiple processing stages based on table search results;
a search logic unit associated with the corresponding data processing pipeline and configured to conduct a table search to generate the table search results; and
a local memory cluster configured to maintain forwarding tables to be searched by the search logic unit.

10. The network switch of claim 9 wherein:
the data processing pipeline, the search logic unit, and the local memory cluster are all identified by one virtual switch ID of the virtual switch instance.

11. The network switch of claim 9 wherein:
the table search includes one of hashing for a Media Access Control (MAC) address look up, Longest-Prefix Matching (LPM) for Internet Protocol (IP) routing, wild card matching (WCM) for an Access Control List (ACL) and direct memory access for control data.

12. The network switch of claim 9 wherein:
the data processing pipeline is allowed to access its own local memory cluster only.

13. The network switch of claim 9 wherein:
the each data processing pipeline is configured to access other memory clusters in addition to or instead of its own local memory cluster through its corresponding search logic unit if the tables to be searched are stored across multiple memory clusters.

14. The network switch of claim 9 wherein:
the data processing pipeline further comprises a plurality of lookup and decision engines (LDEs) connected in a chain, wherein, as one of the processing stages in the data processing pipeline, each LDE is configured to generate a master table lookup key for the data packets received and to process/modify the data packets received based on search results of the tables by the search logic unit using the master table lookup key.

15. The network switch of claim 14 wherein:
the search logic unit is configured to accept and process a unified table request from its corresponding data processing pipeline, wherein the unified table request includes the master table lookup key.

16. The network switch of claim 15 wherein:
the search logic unit is configured to collect and transmit the search results back to the requesting data processing pipeline in a unified response format as a plurality of result lanes.

17. A method to support multiple virtual switch instances, comprising:
executing a plurality of network switch control stacks on a control CPU of a network switch, wherein each of the network switch control stacks is configured to manage and control operations of one or more virtual switch instances of a switching logic circuitry of the network switch;
partitioning said switching logic circuitry into a plurality of said virtual switch instances, wherein each of the virtual switch instances is provisioned and controlled by one of the network switch control stacks and is dedicated to serve and route data packets for a specific client of the network switch.

18. The method of claim 17 further comprising:
implementing a network communication protocol for data communication with the client via a network operating system (NOS) in each of the network switch control stacks;
controlling routing configuration of the virtual switch instances via a switch software deployment kit (SDK) in the network switch control stack; and
controlling and configuring a configurable communication bus between the network switch control stack and the virtual switch instances via a switch configuration interface driver in the network switch control stack.

19. The method of claim 17 further comprising:
controlling only one virtual switch instance via one of the network switch control stacks and controlling different virtual switch instances by different network switch control stacks.

20. The method of claim 17 further comprising:
controlling multiple of the virtual switch instances via one of the network switch control stacks.

21. The method of claim 17 further comprising:
partitioning a plurality of I/O ports among the plurality of virtual switch instances and controlled by the network switch control stacks, wherein each of the I/O ports is configured to transmit the data packets between the client and its corresponding virtual switch instance independent and separate from the data traffic between other clients and their virtual switch instances.

22. The method of claim 17 wherein:
processing and routing the data packets through multiple processing stages based on table search results via a data processing pipeline in each of the virtual switch instances;
conducting a table search to generate the table search results via a search logic unit associated with the corresponding data processing pipeline; and
maintaining forwarding tables to be searched by a local memory cluster in the virtual switch instance.

23. The method of claim 22 further comprising:
allowing the data processing pipeline to access its own local memory cluster only.

24. The method of claim 22 further comprising:
allowing the each data processing pipeline to access other memory clusters in addition to or instead of its own local memory cluster through its corresponding search logic unit if the tables to be searched are stored across multiple memory clusters.

25. The method of claim 22 further comprising:
connecting a plurality of lookup and decision engines (LDEs) in the data processing pipeline in a chain, wherein, as one of the processing stages in the data processing pipeline, each LDE is configured to generate a master table lookup key for the data packets received and to process/modify the data packets received based on search results of the tables by the search logic unit using the master table lookup key.

26. The method of claim 25 further comprising:
accepting and processing a unified table request from its corresponding data processing pipeline, wherein the unified table request includes the master table lookup key.

27. The method of claim 26 further comprising:
collecting and transmitting the search results back to the requesting data processing pipeline in a unified response format as a plurality of result lanes.
